(19) United States
(12) Patent Application Publication
(10) Pub. No.: US 2009/0268756 A1
(43) Pub. Date: Oct. 29, 2009

(54) Method for Reserving Bandwidth in a Network Resource of a Communications Network

(75) Inventor: Michael Frantz, München (DE)

Correspondence Address: K&L Gates LLP, P.O. BOX 1135, CHICAGO, IL, 60690, US

(73) Assignee: Nokia Siemens Networks GmbH & Co. KG, München (DE)

(21) Appl. No.: 11/992,494

(22) PCT Filed: Aug. 23, 2006
(86) PCT No.: PCT/EP2006/008249

§ 371 Date: Mar. 21, 2008

(30) Foreign Application Priority Data
Sep. 22, 2005 (EP) 05020624.2

(51) Int. Cl. H04J 3/22

(52) U.S. Cl. 370/468

(57) ABSTRACT

A method for reserving bandwidth in a network resource in a communication network with network links which the network resource includes, manages a transmission channel for a service, varies the bandwidth for each network resource on the transmission channel on the basis of a statistical value, and defines and manages network links with different bandwidth for all network capacities involved in the service.

The invention specifies a method for reserving bandwidth in a communication network, particularly in an Ethernet based network. In particular, it specifies a method for reserving bandwidth in a network resource, such as a network link.

To be able to guarantee the same quality or availability for utilities which are implemented via an Ethernet based communication network, such as ATM (Asynchronous Transfer Mode—a network protocol which encodes data into small cells characterized by a fixed size) or SDH (Synchronous Digital Hierarchy—a standard for digital communication using optical fibers) based transmission networks, it is necessary to manage the network's bandwidth effectively using a management system.

By way of example, the management should avoid overbooking available bandwidth in the network for utilities which require a guaranteed bandwidth. These may be services of a utility which need to be able to be transmitted at any time, particularly in emergencies, where it is necessary to intervene in the control of an appliance, for example.

The management should take account of services which require different bandwidths for the various network resources used by a service. In this context, the network resource comprises network elements and network links. It can be understood as a means for transmitting data in a network.

The term “utility” is understood to mean a utility for a customer, such as TV, VoIP (Voice over Internet Protocol), Internet access or Video on Demand.

The term “service” is understood to mean an object in a management system, for example a software based object which implements a utility for one or more customers.

The term “network link” or “link” is understood to mean a physical or logical connection between two ports on different network elements or the same network element. In this context, an example of a network element is a switch. Examples of a switch would be a “bridge” or DSLAM (Digital Subscriber Line Access Multiplier), which is a multiplexer which allows customers to access DSL utilities using twisted copper wires.

One problem to be solved is that of specifying means or methods which allow better utilization of the bandwidth available in a communication network.

The invention specifies a method in which a transmission channel is managed in a communication network for a service, the bandwidth for each resource on the transmission channel being varied on the basis of a statistical value.

In this context, the resource preferably comprises a network link. The statistical value preferably comprises the number of users of the service. An example of a user is a customer who is using or could use a service.

The invention also specifies a network management system having a network capacity regulator which is connected to the communication network, which is controlled by a control program and which can be used to carry out said method.

The method and network management system result in the advantage that dynamic bandwidth reservation, for example in contrast to static reservation, is made possible.

A network management system which carries out said method for reserving bandwidth in a network link produces the further advantage that network links between individual network elements (point to point), between a network element and a plurality of network elements (point to multipoint) and between two groups of a plurality of network elements (multipoint to multipoint) can be defined and managed with a nonlinear, i.e. with a different, bandwidth for all network capacities involved in a service. There is thus no need for any complex bandwidth configurations for the total of all the links involved in the network.

Another advantage is that the bandwidths can be staggered as desired and do not need to be managed in prescribed bandwidth steps.

In line with one embodiment of the method, to reserve bandwidth for a service:
the number of users to be expected to use the network is ascertained,
the bandwidth required for the service is multiplied by the number of users to be expected in order to obtain a bandwidth value,
the bandwidth for each network link with this bandwidth value is reserved for the service.

In this case, the bandwidth for a service may be different for each network link.

In line with another embodiment of the method, the statistically ascertained number of users is taken into account for calculating the bandwidth on the basis of the maximum number of possible users.

It is beneficial if the bandwidth value is calculated on the basis of the formula (N_{K}×D)×(N_{Ke}/N_{K}) where
N_{K} is the number of users registered for a service,
D is the bandwidth required for the service,
N_{Ke} is the actual number of users to be expected who use the service simultaneously.

Alternatively, the bandwidth value can be calculated on the basis of the formula (N_{K}×D)×A, where
N_{K} is the number of users registered for a service,
D is the bandwidth required for the service,
A is a reduction factor.

The reduction factor can be formed on the basis of the number of users to be expected.

To provide bandwidth in an entire network, the bandwidth value can be ascertained and provided for a plurality of related network links used for a service together. It is particularly beneficial if the bandwidth value for network links is ascertained and provided in a VLAN.

In line with another embodiment, the route or routes for which particular bandwidths have been reserved and which ascertain the service can be defined by the configuration of a VLAN in the network. This defines a logical area in the network which is characterized exclusively by network links with optimized bandwidth reservations.

If the network has alternative, “protected” routes, the bandwidth can be reserved for a 1:n safeguard. Alternative routes are those which are activated when an existing transmission channel is faulty, which means that the data traffic is diverted by means of this alternative route. In this case, the number n is the number of possible alternative routes which can be ascertained using STP (Spanning Tree Protocol) for example. Thus, bandwidth is reserved on the link only once or in reduced form on the basis of the number of alternative routes.

The subject matters described are explained in more detail using the figures and exemplary embodiments which follow.

In the drawing:

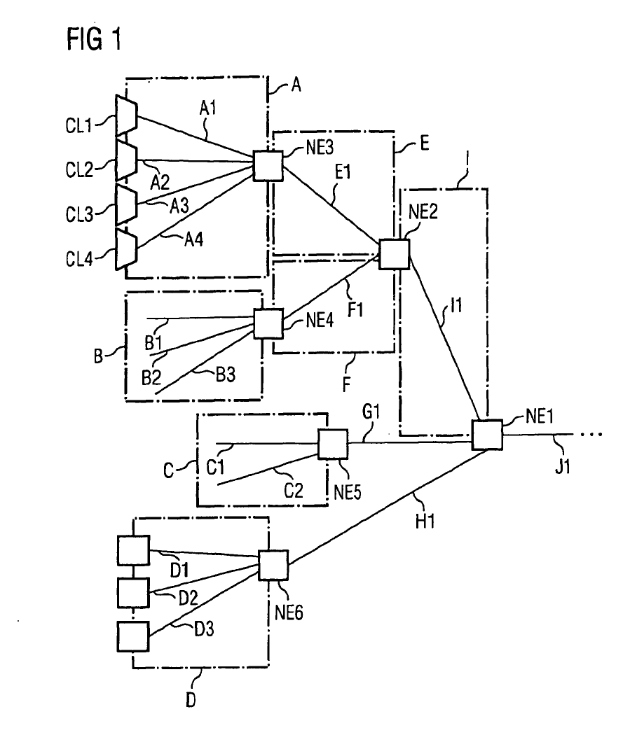

FIG. 1 shows a network in which different physical bandwidths are available in different links,

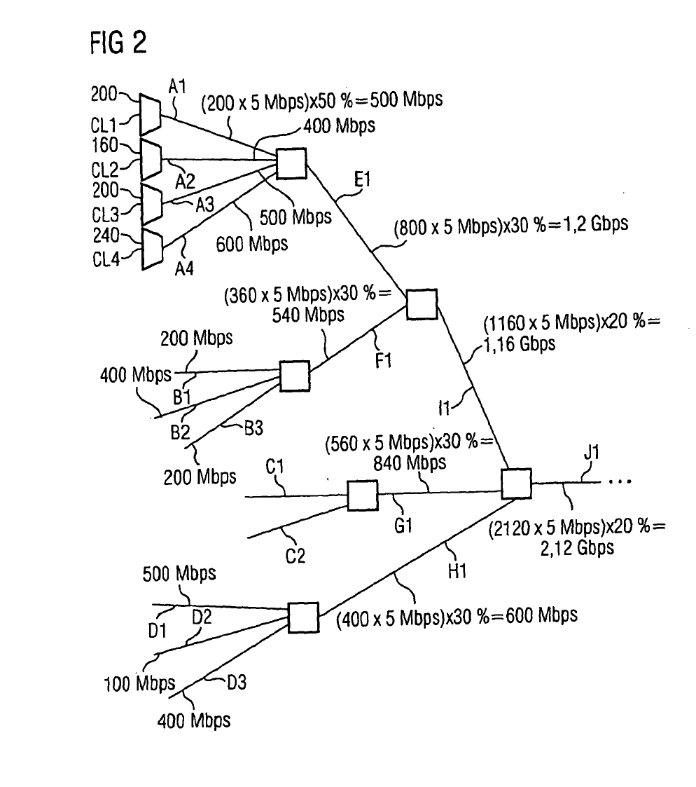

FIG. 2 shows a network based on FIG. 1, with a nonlinear distribution of the bandwidth reserved for a service,

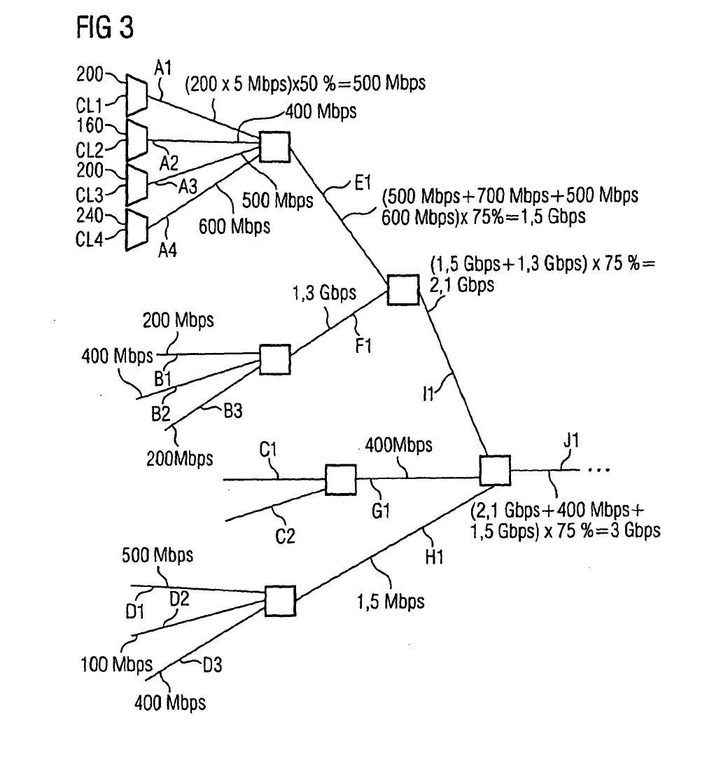

FIG. 3 shows a network based on FIG. 1, with a second distribution of the bandwidth reserved for a service,

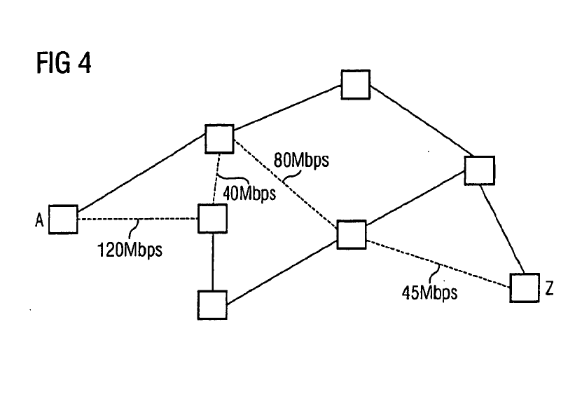

FIG. 4 shows an alternative network whose path has been defined using a VLAN and reserves different bandwidths for one e2e service per network link.

In communication networks, it is possible to reserve bandwidth for a service which can be managed by a network capacity regulator. In this context, it can be assumed that no more than a particular number of customers N_{Ke}, for example 50% of the customers N_{K} registered for the utility, actually use the service on a terminal. Accordingly, it is possible for a bandwidth, for example on the links between two network elements or switches, to be reserved in the network.

In common jargon, a network capacity regulator is also called a resource controller, which manages the bandwidths which have been previously reserved for a service in the management system. This may be prior reservation for planning purposes which takes account, inter alia, of how many customers can use the service simultaneously. In this case, it is normally not possible or admissible to overbook the previously reserved bandwidth. In a management system, it is possible to see the managed services and the bandwidths previously reserved by the network capacity regulator.

FIG. 1 shows, together with the description which follows, how bandwidth is reserved for the links A1 to JI, which together collect the network traffic, said bandwidth being obtained from the total of the bandwidths for the terminals.

Dashed box A contains a total of four links A1 to A4 between a network element NE3 and a plurality of terminals CL1 to CL4. The terminals CL1 to CL4 respectively cater for a plurality of customers who have mobile receivers or a computer, for example.

By way of example, CL1 will provide a service for 200 customers, CL2 will provide a service for 160 customers, CL3 will provide a service for 200 customers and CL4 will provide a service for 240 customers. Should a transmission rate of 5 Mbps be necessary for the service or for connecting a customer, and if it is assumed that in each case only 50% of the customers actually demand or download or use the service at the same time, a bandwidth of 500 Mbps would be necessary for the link A1, which is arranged between CL1 and NE3. This number is obtained from the following calculation: number of customers (N_{K})×required bandwidth for the service (D)×customers actually using the service as a percentage (N_{K}/N_{Ke}). For A1, this is known to be (200×5 Mbps)×50%=500 Mbps. If the bandwidths of the remaining links A2 to A4 between the terminals and the network element NE3 are summed, the result is a total bandwidth of 2 GB from the area A identified by the dashed box.

The figure contains further links B1 to B3 for the summed area B, links C1 and C2 for the summed area C and links D1 to D3 for the summed area D. By way of example, the service allocates the links the following bandwidths:

| | | | | | |
|---|---|---|---|---|---|
| B1: | 200 Mbps | C1: | 800 Mbps | D1: | 500 Mbps |
| B2: | 400 Mbps | C2: | 400 Mbps | D2: | 400 Mbps |
| B3: | 200 Mbps | | | D3: | 400 Mbps. |

In the area I, the summed bandwidths from the areas E and F or A and B now converge. On the basis of the aforementioned calculation, this results in a required bandwidth of 2.8 GB for the area I or for the link I1.

If the bandwidths of the remaining links C1 to D3 are now summed and added to the bandwidth of I1 (2.8 GB), the result is a required bandwidth in the link J1 of 5.2 GB in total.

This addition results in an ever greater bandwidth in the summed links which requires a large proportion of the bandwidth which a link provides. This means that sometimes no bandwidth remains for other services. It is also possible that the links which transmit the summed traffic cannot provide the necessary bandwidth, since the total of the summed bandwidths, such as in the link I1, is greater than the available bandwidth.

A method which circumvents this restriction involves deliberately setting the bandwidths of the links in nonlinear fashion in order to save bandwidth. The reserved network resources are thus theoretically overbooked.

It may also be necessary in a network to provide a service for which different bandwidths are required for the different paths or links for the services, such as in the case of TV services. In this case, the required bandwidths may be dependent on the number of channels which are provided on a regional basis and which may therefore be different. As far as possible, the individual TV channels are transmitted on the service's various routes only once, i.e. the signal is multicast in the distributing network elements. This results in different bandwidth use for the various network capacities on the basis of the channels which have been provided for a path of the service.

Although these methods are beneficial on account of the simple computability and implementability, the summing of the stipulated bandwidths from a user end A to a provider end Z results in a bandwidth requirement which possibly cannot be met. If the bandwidth needs to be provided in an optimized form, for example in order to save bandwidth or when capacity is low, it is possible to calculate the bandwidths per link individually using an operator, a controller adjusted for this purpose or using a suitable program. The transmission capacity of the transmission network is thus managed in detail. This may result in a relatively high level of complexity, particularly for larger networks.

In FIG. 2, the end points CL1 to CL4 in the network at the user end cater for the same number of customers as in the previous example (CL1=200 customers, CL2=160 customers, CL3=200 customers and CL4=240 customers), the bandwidths having been summed linearly. In line with this exemplary embodiment, the bandwidth to be provided is ascertained on the basis of the number of customers who are permitted to use a service at the same time, however. The bandwidths of the respective links are indicated directly in this figure. In contrast to the previous example, a plurality of reduction factors A are used on the basis of the number of customers:
0 to 300 customers=50%
301 to 1000 customers=30%
1001 to 3000 customers=20%
3001 to 4000 customers=15%

To clarify, the reduction factors A are underlined in the figure. The reduction factor thus relates to the number of customers using the service which is actually to be expected.

As in the previous example, 5 Mbps are required per service; this value remains configurable, however. In the area A, altogether 800 customers need to be provided with the service, which means that on the basis of the stated formula in the area A in a dashed box a bandwidth of 800×5 Mbps×30%=1.2 Gbps is obtained in the link E1 or in the area E taking account of the staggered reduction factor. By contrast, in the area B, 360 customers converge, which on the basis of 360×5 Mbps×30% results in a bandwidth of 540 Mbps for the link F1 or for the area F. If the areas E and F are added, the result is a total of 1160 customers to be catered for, which results in a necessary bandwidth in the link I1 of 1.16 Gbps on the basis of 1160×5 Mbps×20%. In this case, a reduction factor A of 20% has been used, for example, which means that with a load of 1160 possible customers there are actually only 20% using the service. If, on the basis of similar calculation, it turns out that the bandwidths required for the links G1 and H1 are 840 Mbps and 600 Mbps, respectively, and it turns out that altogether 1060 customers need to be catered for in the areas C and D, this means that the link J1 has a required bandwidth of 2120×5 Mbps×20%=2.12 Gbps. This last calculation produces another example, where a reduction factor of 20% has been used in line with the customer load which is actually to be expected.

The reduction factor A is thus based on the assumption that the statistical mean for the customers using a service simultaneously is reduced the more customers are provided with data via a link, i.e. the probability that with an increased number of customers these customers use the same service simultaneously is low. Using this approach, the bandwidth to be provided in the network is reduced dynamically. This in turn results in the advantage that more customers can use a service simultaneously or a network provider can provide a service for more customers.

Although the reduction factors are shown as fixed in this exemplary embodiment, they can be configurable, for example using a suitable program product which ascertains a suitable reduction factor on the basis of the number of customers to be catered for.

The exemplary embodiment presented here is particularly suitable for supporting Video on Demand in the network.

FIG. 3 shows a third exemplary embodiment, in which the required bandwidth in the sectors A, B, C and D, i.e. for the links A1 to A4, B1 to B3, C1 and C2 and D1 to D3 connected directly to the customers, is ascertained on the basis of the number of customers who are permitted to use a service, for example 50%. This would mean that bandwidths of 500, 400, 500 and 600 Mbps respectively are reserved for the links A1 to A4, resulting from the calculation: number of customers×5 Mbps×50%.

For the sectors E and F, which are further away relative to the customers, on the other hand, the bandwidth to be provided is ascertained on the basis of a reduction factor, in this case A=75%. This means that for the link E1, for example, a bandwidth reservation of 1.5 Gbps is obtained, according to the calculation (500 Mbps+400 Mbps+500 Mbps+600 Mbps)×75%. This formula could likewise be applied for the links I1 and J1, so that 2.1 Gbps would be provided for link I1 and 3 Gbps would be provided for link J1. The reduction factor may thus be fixed at a value and does not change on the basis of the number of customers using the service.

In this exemplary embodiment, the total for the bandwidth is thus formed from the collecting links and multiplied by the reduction factor. The following data can be input by a program or by an operator in this case:
bandwidth which a service requires,
assumed number of customers who use the service for a first link simultaneously, such as 50%,
reduction factor for the bandwidth to be reserved for the collecting links. This is a percentage value by which the bandwidth in the collecting links needs to be reduced. A fixed value of between 1% and 100% can be input which is used for all summing links. The default value is 100%, which would mean no reduction.

The calculated bandwidths are reserved for this service in the management system, i.e. they may be unavailable for other services, specifically regardless of whether or not the bandwidths for this service are used for the utilities at a given time in the network.

The method is suitable for controlling Ethernet networks in which some of the available capacity is managed by an external network capacity regulator.

If a television service is to be provided for the customer, the management system can identify how many TV channels are transmitted on a link by evaluating the multicast groups in the network element. This information is used to provide sufficient bandwidth in the network.

In line with another exemplary embodiment, a method is provided in which the bandwidth in the collecting links can be reduced by an individual factor. In this case, an individual formula is defined, for example by a program with a suitable knowledge base, such as a database. The program could involve the calculated bandwidth to be provided being checked for a value greater than zero for all network resources. Other procedures are conceivable, such as multiplying the checksum for the reduction factor from the collecting links by a further factor in order to reduce the bandwidth to be reserved again. Alternatively, a reduction factor can be ascertained on the basis of the physical bandwidth of a link. This may be linear or nonlinear.

FIG. 4 shows how an improvement to the aforementioned methods involves services being connected for utilities in a management system which define routes for the services by virtue of the configuration of VLANs (Virtual Local Area Network). In this context, the term VLAN is understood to mean a logically independent network which forms part of a network and is provided with a particular MAC (Media Access Control) address. For network resources which are determined by a route or a path, the bandwidth required for the service is reserved in the management system. The reservation of bandwidths for the network links in a VLAN forms a zone which allows a service to be transmitted only for registered customers of a utility. The VLAN area may be connected using different protocols, for example using STP or MSTP (Multiple Spanning Tree Protocol). The MSTP protocol proposes alternative routes in an environment comprising a plurality of VLANs which are used when a link or network element is faulty. The stated method can also be used to reserve bandwidths on a variable basis for links on such routes.

### LIST OF REFERENCE SYMBOLS

| | |
|---|---|
| A to J | Areas of summed bandwidth |
| CL1 to CL4 | Terminals |
| A1 to J1 | Links |
| NE1 to NE6 | Network elements |

1.-9. (canceled)

10. A method for reserving bandwidth in a network resource in a communication network with network links which the network resource includes, comprising:
managing a transmission channel for a service;
varying the bandwidth for each network resource on the transmission channel on the basis of a statistical value; and
defining and managing network links with different bandwidth for all network capacities involved in the service.

11. The method of claim 10, further comprising:
ascertaining a number of users to be expected for the service who use the network resource;
multiplying the bandwidth required for the service by the number of users to be expected in order to obtain a bandwidth value; and
reserving the network resource with this bandwidth value for the service.

12. The method of claim 1, wherein the bandwidth value is calculated on the basis of a formula (NK
NK is a number of users registered for a service,
D is a bandwidth required for the service, and
A is a reduction factor.

14. The method of claim 12, wherein the reduction factor is formed on the basis of the number of users to be expected.

15. The method of claim 10, wherein the network resource comprises network elements.

16. The method of claim 10, further comprising ascertaining and providing the bandwidth value individually for a plurality of related network resources.

17. The method of claim 10, wherein the network resource is associated with a VLAN.

18. The method of claim 17, wherein one or more routes for which particular bandwidths have been reserved and which ascertain the service are defined by a configuration of the VLAN in the network.
